(19) United States
(12) Patent Application Publication
(10) Pub. No.: US 2014/0137401 A1
(43) Pub. Date: May 22, 2014

(54) Kit for Improving the Efficiency of a HVAC System and for Securing a Heat Pump from Theft or Damage

(71) Applicant: Frederick W. Lannert, Albrightsville, PA (US)

(72) Inventor: Frederick W. Lannert, Albrightsville, PA (US)

(21) Appl. No.: 13/680,403

(22) Filed: Nov. 19, 2012

(51) Int. Cl. B23P 15/00

(52) U.S. Cl. CPC B23P 15/00
USPC 29/700

(57) ABSTRACT

A retrofitting kit or system that both improves the efficiency of a heat pump, and inhibits theft or damage to the heat pump, the kit comprising one or more ground anchors connected to or forming part of a support frame, a plurality of transpired solar collector panels for attachment to or forming part of the support frame for forming an envelopment around a heat pump, an exhaust shroud for isolating heat pump exhaust ejected from the heat pump, the exhaust shroud adapted to fit over the exhaust portion of a heat pump, fastening means for fastening the exhaust shroud to the heat pump, an exhaust conduit connected to or forming part of the exhaust shroud, the exhaust conduit extending from the exhaust shroud through the envelopment at an exhaust port for isolating and conveying to an area external of the envelopment, the exhaust gas ejected from the heat pump, and a dilution air damper formed into the envelopment for selectively allowing heat pump inlet air to pass directly into the envelopment via the air damper, rather than solely through the transpired solar collectors forming the envelopment.

### CROSS REFERENCE TO RELATED APPLICATIONS

Not Applicable.

### STATEMENT AS TO FEDERALLY SPONSORED RESEARCH Not applicable.

### BACKGROUND OF INVENTION

a. Field of Invention

The invention relates generally to the field of heating and air conditioning. More particularly, the invention refers to a retrofitting kit or system that both improves the efficiency of a HVAC system, and inhibits theft or damage to a heat pump.

b. Background of Invention

With the proliferation of the theft and vandalism of heat pumps and their internal components for metal content, there is an increased need to protect a property-owner's HVAC heat pump from theft or damage. Many building structures have heat pumps located immediately outside the structure on a concrete pad or the like. Most are completely unprotected from theft, vandalism, or damage. Accordingly, there is a need to shelter or protect exposed heat pumps from theft or damage.

Transpired solar collectors are known as a means of utilizing solar radiation to heat incoming air for downstream use. A typical transpired solar collector comprises an absorber panel that has a plurality of perforations or openings by which air flows from an outside face of the absorber panel into a plenum or air collection space behind the absorber panel. Fans are typically used to pull or suction the outside air through the perforations. The air is then routed downstream for its particular use.

U.S. Pat. No 5,692,491 is an example of a transpired solar collector and briefly describes the art relating to glazed and unglazed solar collectors. U.S. Pat. No 5,692,491 discloses an unglazed transpired solar collector having a low thermal-conductance absorber. Transpired solar collectors are typically deployed on the south facing sides of buildings, and the solar heated air drawn through the collectors is routed into the building and often mixed with ventilation air.

Patent Publication U.S. 2012/0126971 A1 discloses the dual purpose of providing security for air conditioner/heat pump units and utilizing the exhaust gas from those units to generate electricity. The containment cage with its lockable door, anti-tamper sensor, and alarm system provides the security while the wind turbine utilizes the exhaust of the protected air conditioner/heat pump unit to produce electricity.

US 2009/0255646 A1 discloses a heat pump system comprising a heat pump arranged to permit taking up of thermal energy from outdoor air and the giving off of thermal energy to another medium, and an external space adapted to permit heating of the outdoor air by the use of solar radiation, the system being so arranged as to conduct the outdoor air to the heat pump via the external space. The disclosure characterizes the heat pump system having means for regulating the flow of the outdoor air to the external space.

### SUMMARY OF INVENTION

One object of the invention is to provide a kit, system, and method for retrofitting heat pump systems that are already in place and in use to heat/cool homes and businesses. An object of the invention is to improve the heating and/or cooling efficiency of heat pump systems. An object the invention is to secure heat pumps from theft, vandalism, or damage. An object of the invention is to pre-filter intake air to reduce wear on a heat pump. An object of the invention is to provide a more aesthetic exterior of a building.

The instant invention is directed to a kit for improving the efficiency of a heating system and for securing a heat pump from theft or damage. The kit includes one or more ground anchors connected to or forming part of a support frame. Further included in the kit are a plurality of transpired solar collector panels that are attached to or form part of the support frame for forming an envelopment around a heat pump. The kit further includes an exhaust shroud for isolating heat pump exhaust ejected from the heat pump. The exhaust shroud is adapted to fit over the exhaust portion of a heat pump and be fastened to the heat pump with a fastener. An exhaust conduit is connected to or forms part of the exhaust shroud. The exhaust conduit extends from the exhaust shroud through the envelopment at an exhaust port for isolating and conveying to an area external of the envelopment, the exhaust gas ejected from the heat pump. A dilution air damper is formed into the envelopment for selectively allowing heat pump inlet air to pass directly into the envelopment via the air damper, rather than solely through the transpired solar collectors forming the envelopment.

In an embodiment of the present invention, the ground anchor is selected from the group of a ground screw, a concrete form, and/or anchor bolts. The ground anchor is connected to the support frame and/or the transpired solar collectors, or otherwise employed to fix the envelopment to the underlayment or ground beneath the heat pump.

In an embodiment of the present invention, the support frame includes square tubing having slip fittings.

In an embodiment of the present invention, the kit of further includes a skirt for attaching to the envelopment at a periphery closest to the ground for minimizing the leakage of air between the ground and the periphery closest to the ground.

In an embodiment of the present invention, one or more of the plurality of transpired solar collector panels are dark colored to maximize absorption of solar energy.

In an embodiment of the present invention, the transpired solar collector panels are replaced with solar rejection panels for use in adding to system cooling efficiency. A plurality of solar rejection panels are attached to for form part of the support frame for forming the envelopment around the heat pump.

In an embodiment of the present invention in cooling mode, one or more of the plurality of solar rejection panels are light colored to maximize the rejection of solar energy.

In an embodiment of the present invention, the kit further includes liquid misters for attachment to a water source for spraying water onto the envelopment, thereby causing the envelopment to cool via direct cooling and/or evaporative cooling.

Additional features, advantages, and embodiments of the invention may be set forth or apparent from consideration of the following detailed description. Moreover, it is to be understood that both the foregoing summary of the invention and the following detailed description are exemplary and intended to provide further explanation without limiting the scope of the invention.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a partial schematic perspective of an embodiment kit installed to a heat pump;

FIG. 2 is a partial schematic perspective of an embodiment of the exhaust shroud of the kit fixed to a heat pump;

FIG. 3 is a partial schematic perspective of an embodiment of the exhaust shroud of the kit fixed to a heat pump according to an embodiment of the present invention; and

FIG. 4 is a partial schematic perspective of an embodiment kit installed to a cube or box shape heat pump.

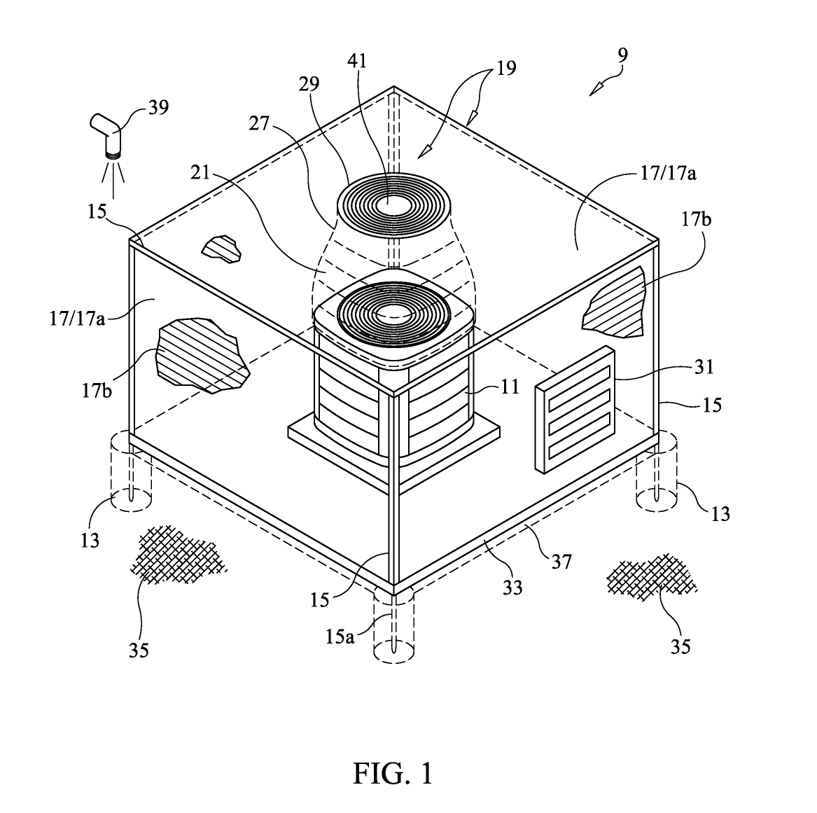

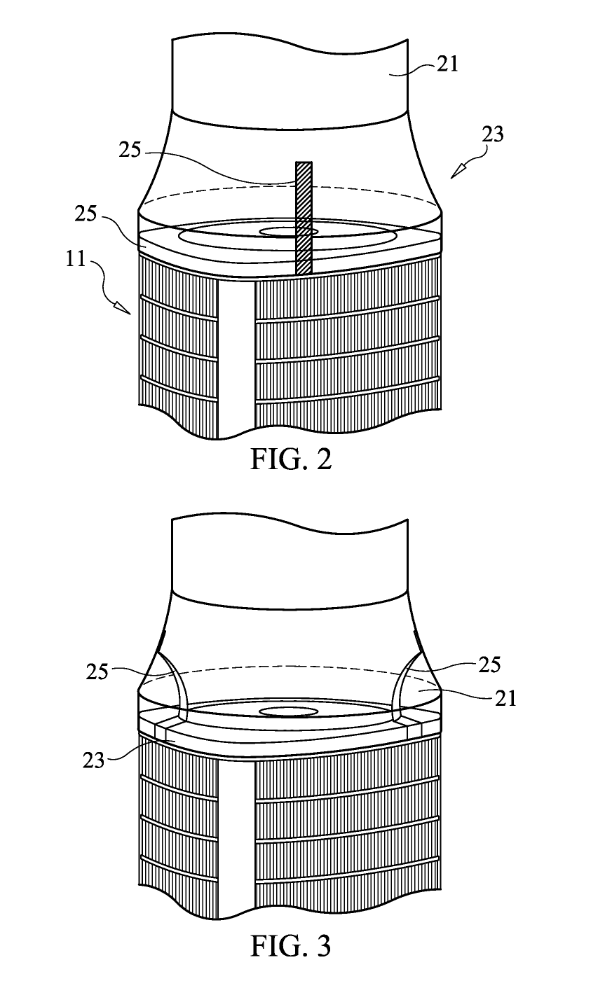

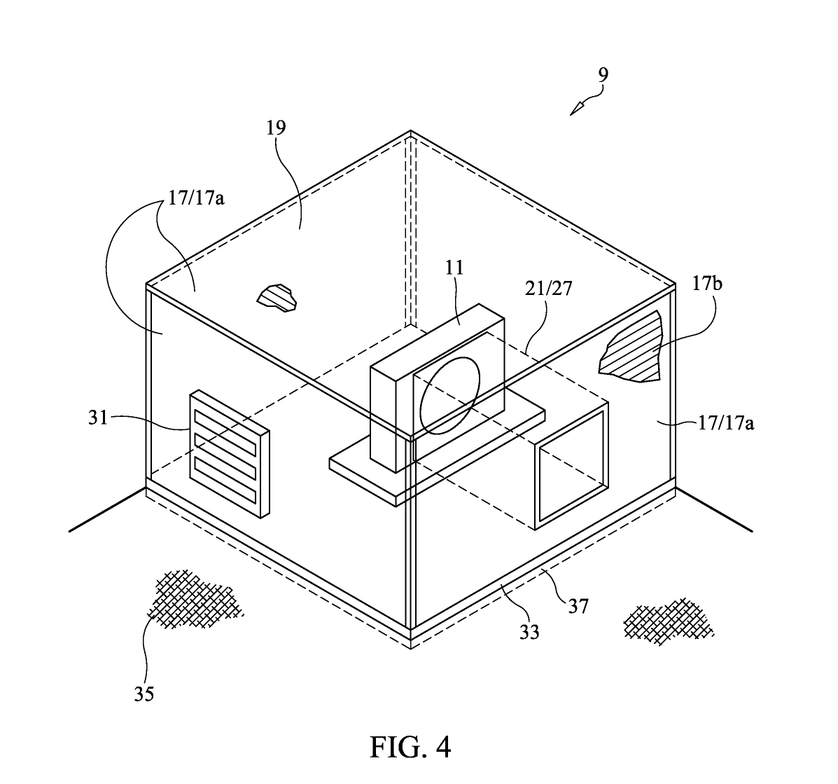

### DETAILED DESCRIPTION OF THE EMBODIMENTS

Referring now to the Figures, embodiments of the present invention are directed to a kit or system 9 for improving the efficiency of a heating system and for securing a heat pump 11 from theft or damage. The heat pump 11 shown is a cylindrical type heat pump where intake air is drawn in radially and exhaust air is ejected vertically out the top at an exhaust portion. The kit 9 also applies to other heat pump designs, such as a box-shaped heat pump, where air is drawn through the box from one or more faces and exhausted through a one or more other faces. The kit also applies to other heat pump designs so long as the heat pump has intake air location separate from exhaust air location.

A heat pump operates to heat/cool refrigerant used in a heating/cooling system as follows. A fan draws air into a heat pump from an intake portion, and the air passes across the coils of a heat pump, wherein heat exchange occurs between the air and the coils, and the exhaust air exits the heat pump exhaust. During heating season, heat is extracted from the intake air as it passes over the refrigerant coils. Similarly, during cooling season, heat is exchanged from the refrigerant coils to the intake air as it passes over the refrigerant coils, and the heated air is then ejected via the heat pump exhaust. The principle of increasing the efficiency of a heating system employing a heat pump during heating season involves utilizing solar energy to preheat the intake air for the heat pump.

The kit 9 of the present invention is designed to enable the construction of an envelopment 19 around a heat pump 11 utilizing transpired solar collector panels 17. The forming of the envelopment 19 aids in preventing theft or damage to the heat pimp 11 contained therein.

Transpired solar collector panels 17 preheat air using the energy of the sun. The air is heated as it is pulled through the transpired solar collector panels 17 forming the envelopment 19. Once preheated, the air continues to travel into the heat pump 11, where the thermal energy of the air is exchanged as it passes over the coils of the heat pump 11. After passing over the coils of the heat pump 11, the air exits the heat pump 11 at an exhaust portion 23. Moving the air through the heat pump 11 is a fan that is integral to the heat pump 11 being retrofitted.

A typical transpired solar collector 17 comprises an absorber panel that has a plurality of perforations or openings by which air flows from an outside face of the absorber panel into a plenum or air collection space behind the absorber panel. Reference to U.S. Pat. No. 5,692,491 is one example of a transpired solar collector 17. In the marketplace is known solar collector panels made by SolarWall® by Conserval Engineering Inc., which can be employed as the transpired solar collector 17 of the present invention kit 9.

The kit 9 includes one or more ground anchors 13 connected to or forming part of a support frame 15. Ground anchors 13 are understood as a mechanical means of fixing the support frame 15 to the underlying substrate, which is typically the ground 35, but can be other, such as a roof, concrete, or some other fixed structure. In an embodiment of the present invention, the support frame 15 includes square tubing having slip fittings. However, any suitable framing material sufficient to support the transpired solar collector panels 17 can be employed.

If the frame 15 is set over the ground, the ground anchors 13 can include what are known as ground screws, such as those made by Krinner®. The support frame may also include legs 15a intended to extend partially below grade or ground 35, and said legs may be secured using cement 13 poured in place. Alternate embodiments of the ground anchors 13 include any structure capable of fixing the frame 15, the collector panels 17, and/or the envelopment 19 to the substrate or ground 35 beneath the envelopment 19.

Further included in the kit 9 are a plurality of transpired solar collector panels 17 that are attached to or form part of the support frame 15 for forming an envelopment 19 around a heat pump 11. The transpired solar collectors 17 are of the type discussed herein. Although shown in the drawings as cubic, the shape of the envelopment 19 formed by the collector panels 17 and/or the support frame 15 can take on any aesthetic shape desired, so long as the envelopment 19 can contain the heat pump 11 within so as to meet the purpose of preheating air fed to the heat pump 11, and permits separate routing of the exhaust air from the heat pump 11 to a location external of the envelopment 19. For example, the aesthetics of the heat pump 11 are transformed from utilitarian to aesthetic in nature by shaping the envelopment 19 like a shed or wall, or by using colors that blend with the building or its surroundings. In an embodiment where the support frame 15 is separately employed, the collector panels 17 are affixed to the support frame as a skin or sheathing with fasteners or the like. In an embodiment of the present invention, one or more of the plurality of transpired solar collector panels 17 are dark colored to maximize absorption of solar energy.

Given that the envelopment 19 is metal, a ground rod and a conductor are used to bond the envelopment to the ground. The ground rod is driven into the ground and then connected to the envelopment 19 with a conductor.

The kit 9 further includes an exhaust shroud 21 for isolating heat pump exhaust ejected from the heat pump 11. The exhaust shroud 21 is adapted to fit over the exhaust portion 23 of a heat pump and to be fastened to the heat pump 11 with a fastener 25. The exhaust shroud 21, preferably is made of a material flexible enough or shaped to fit over the exhaust portion 23. Generically dimensioned exhaust shrouds 21 may be suitable to adapt for connection to the exhaust portion 23 of a range of heat pumps 11 of similar size and shape. Also, exhaust shrouds 21 may be made specifically for the model heat pump 11 being retrofitted with the kit 9. In an embodiment of the present invention, the fastener 25 used to fix the exhaust shroud 21 to the exhaust portion 23 of the heat pump 11 includes double sided Velcro® straps 43 fixed at a first end 43a inside the exhaust shroud 21 that are adapted to be fed through the exhaust grating 41 of the heat pump 11 and then fixed to an outside portion of the exhaust shroud 21 at a second end 43b.

An exhaust conduit 27 is connected to or forms part of the exhaust shroud 21. That is, the exhaust shroud 21 and the exhaust conduit 27 are, in one embodiment, a unitary piece. Alternately, the exhaust shroud 21 is adapted to couple with the exhaust conduit 27. The exhaust conduit 27 extends from the exhaust shroud 21 through the envelopment 19 at an exhaust port 29 for isolating and conveying to an area external of the envelopment 19, the exhaust gas ejected from the heat pump 11. Stated another way, the purpose of the exhaust shroud 21, the exhaust conduit 27, and the exhaust port 29 are to convey the exhaust gas from the heat pump 11 outside and away from the envelopment 19. Although the exhaust port 29 is shown at a top face of the envelopment 19, the exhaust port 29 preferably is located on a vertical face of the envelopment 29 so to minimize the collection of rainwater and debris from collecting in the exhaust shroud 21 and/or the exhaust conduit 27. Exhaust grating may be used to cover the exhaust port 29 and prevent the entry of debris as well. Preferably, the exhaust shroud 21 and/or the exhaust conduit 27 is flexible to allow for seasonal movement of the heat pump 11 relative to the envelopment 19.

Access to the heat pump 11 may be provided by adding a hinged door to the structure. The door may also be transpired solar collector 17 or solar rejection panels 17a. Preferably, the door opens outwardly so that the door seals more completely. In some instances, an access panel constructed of transpired solar collector 17 or solar rejection panels 17a may be utilized.

A dilution air damper 31 is formed into the envelopment 19 for selectively allowing heat pump 11 inlet air to pass directly into the envelopment 19 via the air damper 31, rather than solely through the transpired solar collectors 17 forming the envelopment 19. When a heat pump 11 in is cooling mode, preheating intake air by causing it to pass through the envelopment 19 will make the heat pump 11 less efficient than if there was no envelopment 19 at all surrounding the heat pump 11. Accordingly, the dilution air damper 31 is set with controls, or manually, to open and allow air to flow through the dilution air damper 31 into the heat pump 11, rather than through the solar collector panels 17 forming the envelopment 19.

In an embodiment of the present invention, the kit 9 further includes a skirt 37 for attaching to the envelopment 19 at a periphery 33 closest to the ground for minimizing the leakage of air between the ground and the periphery 33 of the envelopment 19 closest to the ground 35. The skirt 37 preferably is a rubber strip affixed to and extending from the periphery 33 of the envelopment 19 closest to the ground 35 to the ground 35. Other suitable materials are employable so long as the selected materials are sufficient to minimize the leakage of air into the envelopment 19.

For energy efficiency in cooling, in an embodiment of the present invention, the transpired solar collector panels 17 are replaced with solar rejection panels 17a for use in adding to system cooling efficiency. A plurality of solar rejection panels 17a are attached to or form part of the support frame 15 for forming the envelopment 19 around the heat pump 11. In an embodiment of the present invention, the solar rejection panels 17a have perforations or holes that are larger than those employed with respect to transpired solar collectors 17. The larger perforations allow for a larger volume of air to pass through the solar rejection panels 17a for a given time period.

The kit 9 further includes liquid misters 39 for attachment to a water source for spraying water onto the envelopment 19, thereby causing the envelopment to cool via direct cooling and/ or evaporative cooling. The air passing through the envelopment 19 will exchange heat with the envelopment 19 and will then feed into the heat pump 11, causing an efficiency in cooling for the heat pump 11/heating system, relative to uncooled air that does not pass through the envelopment 19. In a preferred embodiment, the liquid misters 39 are adapted to spray liquid onto the solar rejection panels 17a. In an embodiment of the present invention in cooling mode, one or more of the plurality of solar rejection panels 17a are light colored to maximize the rejection of solar energy. In an embodiment of the present invention employed for cooling efficiency, the dilution air damper 31 may be omitted.

In accordance with the inventions described herein, there is a method of reducing the electrical demand of a heat pump 11 of a HVAC system, and securing the heat pump from theft, damage, or vandalism. The method includes constructing an envelopment 19 around the heat pump 11. The envelopment 19 having a surface comprising of transpired solar collectors 17 and/or solar rejection panels 17a as discussed herein. The method further including the step of moving heat pump 11 intake air through the surface prior to entering the heat pump, and ejecting the air at a location external of the envelopment 19.

Although particular embodiments of the invention have been described in detail herein with reference to the accompanying drawings, it is to be understood that the invention is not limited to those particular embodiments, and that various changes and modifications, including the omission of steps or the interchangeability of the order of steps, may be effected therein by one skilled in the art without departing from the scope or spirit of the invention.

What is claimed:

1. A kit for improving the efficiency of a heating system and for securing a heat pump from theft or damage, the kit comprising:
a. one or more ground anchors connected to or forming part of a support frame,
b. a plurality of transpired solar collector panels for attachment to or forming part of the support frame for forming an envelopment around a heat pump,
c. an exhaust shroud for isolating heat pump exhaust ejected from the heat pump, the exhaust shroud adapted to fit over the exhaust portion of a heat pump,
d. fastening means for fastening the exhaust shroud to the heat pump,
e. an exhaust conduit connected to or forming part of the exhaust shroud, the exhaust conduit extending from the exhaust shroud through the envelopment at an exhaust port for isolating and conveying to an area external of the envelopment, the exhaust gas ejected from the heat pump, and
f. a dilution air damper formed into the envelopment for selectively allowing heat pump inlet air to pass directly into the envelopment via the air damper, rather than solely through the transpired solar collectors forming the envelopment.

2. The kit of claim 1, the ground anchor selected from the group of a ground screw, a concrete form, and/or anchor bolts.

3. The kit of claim 1, the support frame including square tubing having slip fittings.

4. The kit of claim 1, further including a skirt for attaching to the envelopment at a periphery closest to the ground for minimizing the leakage of air between the ground and the periphery closest to the ground.

5. The kit of claim 4, wherein one or more of the plurality of transpired solar collector panels are dark colored to maximize absorption of solar energy.

6. A kit for improving the efficiency of a cooling system and for securing a heat pump from theft or damage, the kit comprising:
a. one or more ground anchors connected to or forming part of a support frame,
b. a plurality of solar rejection panels for attachment to or forming part of the support frame for forming an envelopment around a heat pump,
c. an exhaust shroud for isolating heat pump exhaust ejected from the heat pump, the exhaust shroud adapted to fit over the exhaust portion of a heat pump,
d. fastening means for fastening the exhaust shroud to the heat pump,
e. an exhaust conduit connected to or forming part of the exhaust shroud, the exhaust conduit extending from the exhaust shroud through the envelopment at an exhaust port for isolating and conveying to an area external of the envelopment, the exhaust gas ejected from the heat pump, and
f. a dilution air damper formed into the envelopment for selectively allowing heat pump inlet air to pass directly into the envelopment via the air damper, rather than solely through the solar rejection panels forming the envelopment.

7. The kit of claim 6, further including a skirt for attaching to the envelopment at a periphery closest to the ground for minimizing the leakage of air between the ground and the periphery closest to the ground.

8. The kit of claim 7, wherein one or more of the plurality of solar rejection panels are light colored to maximize the rejection of solar energy.

9. The kit of claim 6, further including liquid misters for attachment to a water source for spraying water onto the envelopment thereby causing the envelopment to cool via direct cooling and/or evaporative cooling.
